(19) United States
(12) Patent Application Publication
(10) Pub. No.: US 2019/0225220 A1
(43) Pub. Date: Jul. 25, 2019

(54) AUTONOMOUS DRIVING METHOD FOR VEHICLE

(71) Applicant: PSA Automobiles SA, Poissy (FR)

(72) Inventors: Vincent Laine, Les Clayes Sous Bois (FR); Stephane Feron, Le Plessis Robinson (FR); Celine Taccori Duvergey, Montrouge (FR)

(21) Appl. No.: 16/314,046

(22) PCT Filed: Jun. 29, 2017
(86) PCT No.: PCT/FR2017/051762

§ 371 Date: Dec. 28, 2018

(30) Foreign Application Priority Data
Jul. 6, 2016 (FR) 1656491

(51) Int. Cl. B60W 30/165; B60W 30/18; B60W 50/14; G05D 1/02; G05D 1/00; G08G 1/00; G08G 1/16

(52) U.S. Cl. CPC B60W 30/165; B60W 30/18163; B60W 50/14; G05D 1/0293; G05D 2201/0213; G08G 1/22; G08G 1/167; B60W 2540/04; G05D 1/0088

(57) ABSTRACT

Autonomous driving method which allows a vehicle to maintain a driving situation immediately behind a target vehicle, characterized in that it includes the following steps:
detection and recording of the distinctive characteristics of the target vehicle (E2) by first means of detection,
autonomous driving immediately behind the said target vehicle (E3), executed by autonomous driving means,
detection by second means of detection of a situation in which the said vehicle is no longer or will no longer be in a driving situation immediately behind the target vehicle,
verification by control means of the possibility of executing at least one lane change according to a predefined scenario (E4),
execution, by the autonomous driving means of the aforementioned, of at least one lane change according to the said predefined scenario so that the said vehicle can resume the driving situation immediately behind the target vehicle (E5).

### CROSS-REFERENCE TO RELATED APPLICATIONS

This application is the US National Stage under 35 USC § 371 of International App. No. PCT/FR2017/051762 filed Jun. 29, 2017, which claims priority to French App. No. 1656491 filed Jul. 6, 2016.

### BACKGROUND

This invention generally concerns an autonomous driving method for a vehicle. In particular, the invention concerns an autonomous driving method which allows a vehicle to maintain a driving situation immediately behind a target vehicle. The invention also concerns an autonomous driving device, or a vehicle allowing such a method to be implemented.

Autonomous driving methods allowing for a target vehicle to be followed are known from prior art. EP1457948 describes a method in which the vehicle determines a probability of intersection between the said vehicle and a third vehicle and terminates the vehicle following function in the event that the probability of intersection becomes greater than or equal to a predetermined value.

However, this system disclosed in EP1457948 presents the disadvantage of requiring constant communication with the target vehicle and therefore can only function by following a specially equipped target vehicle.

### SUMMARY

One of the goals of this invention is to respond to the disadvantages of the prior art mentioned above and, in particular, to propose an autonomous driving method which permits a vehicle to maintain a driving situation immediately behind any type of target vehicle, for example, a non-autonomous vehicle.

Accordingly, a first aspect of the invention concerns an autonomous driving method which allows a vehicle to maintain a driving situation immediately behind a target vehicle, characterized in that the method includes the steps of:
detecting and recording of the distinctive characteristics of the target vehicle by a first detection means,
autonomously driving immediately behind the target vehicle, means of an autonomous driving means,
detection by second detection means of a situation in which the vehicle is no longer or will no longer be in a driving situation immediately behind the target vehicle,
verification by a control means of the possibility of executing at least one lane change according to a predefined scenario,
execution, by the autonomous driving means of the at least one lane change according to the predefined scenario so that the vehicle can resume the driving situation immediately behind the target vehicle.

Such a method therefore enables the autonomous following of any target vehicle located immediately in front of the vehicle implementing the method, which is to say that the two vehicles are driving in the same traffic lane without an intermediate vehicle between the two vehicles. In this way, autonomous driving can be carried out in the direct view of any target vehicle, which is to say without vehicle-to-vehicle communication. The method according to this invention also allows for autonomous driving to be maintained, including when the target vehicle changes lane or when a third vehicle comes between the vehicle and the target vehicle. Finally, the method according to this invention can be implemented by an autonomous device or an autonomous car according to the state of the art and does not require any specific new equipment.

Advantageously, the method includes a subsequent step for recognizing the target vehicle by the first detection means, using the distinctive characteristics recorded during the step for detecting and recording the distinctive characteristics of the target vehicle. This step helps ensure that the driving situation immediately behind the target vehicle has been correctly identified in order to autonomously resume autonomous driving immediately behind the target vehicle.

Advantageously, if the verification step determines that a lane change according to the predefined scenario is not possible, this verification step will be started again according to another scenario, including at least one configuration different from the predefined scenario. For example, the predefined scenario can be configured by the vehicle manufacturer and the other scenario can be configured by the vehicle owner, for example at the moment of the vehicle's purchase or before the journey. The different configuration may be the duration or the distance of the lane change, or even the speed of the vehicle during the lane change. For example, the speed of the vehicle during the lane change can be constant, which is to say equal to the driving speed in the predetermined scenario, or can feature an acceleration for the other scenario, which is greater than the driving speed of the vehicle in its traffic lane.

This embodiment therefore allows the owner or an occupant of the vehicle to adapt the autonomous driving method to their desired comfort or to the local or envisaged driving conditions.

Advantageously, a step in which, by autonomous driving means, the autonomous driving means executes at least one lane change according to the other scenario subject to the prior approval of an occupant of the vehicle, via an interface. An occupant of the vehicle can thus intervene in the autonomous driving in order to adapt it to their desired comfort or to the driving conditions without having to deactivate the autonomous driving device, which is to say without directly resuming control of the vehicle. The driver therefore acts simply on the autonomous driving strategy. For example, the interface means include a touch screen, a voice interface and/or control levers or buttons.

Advantageously, the method also includes an extra lane change, allowing for a third vehicle, which has come between the vehicle and the target vehicle, to be overtaken. Hence, such a method can autonomously resume the following of the same target vehicle if a third vehicle comes between the vehicle and the target vehicle.

The method accordingly can include a communication step via a telematics system, to inform the target vehicle or an occupant of the target vehicle that the vehicle is no longer in a driving situation immediately behind the target vehicle. Hence, the target vehicle or the driver of the target vehicle can adapt their driving or can contact the occupant of the vehicle.

Alternatively or in combination with this, the communication step via a telematics system can transmit a request for the adaptation of the driving of the target vehicle, for example, in cases where the target vehicle is an autonomous vehicle.

A second aspect of the invention is an autonomous driving device including at least first detection means, a second detection means, control means, and autonomous driving means configured to implement the autonomous driving method according to the first aspect of the invention.

A final aspect of the invention concerns a vehicle including at least one autonomous driving device according to the second aspect of the invention.

For example, the first and second detection means, the control means, and the autonomous driving means include one or more sensors, selected from amongst: visible light-sensitive camera, infrared light-sensitive camera, radar, laser radar and ultrasonic sensor, as well as at least one computer.

Finally, the computer for the autonomous driving means can be the same computer as the computer for the first and second detection means and of the control means, or it can be one or more different computers functioning together. This at least one computer for the autonomous driving means enables the actuators of the autonomous driving means to receive commands in order to execute the autonomous driving using the data from the sensors or from another computer.

### DESCRIPTION OF THE FIGURES

Other characteristics and advantages of this invention will appear clearer upon reading the detailed description below of an embodiment of the invention, given as an example that is in no means restrictive and illustrated with the annexed images, in which:

FIG. 1 presents a basic diagram of an autonomous driving device according to this invention,

FIG. 2 describes an autonomous driving method according to this invention.

### DETAILED DESCRIPTION

Within the context of this description, the term “vehicle” applies to any vehicle implementing the autonomous driving method according to this invention, and the expression “target vehicle” or “followed vehicle” applies to the vehicle followed by the vehicle implementing the autonomous driving method according to this invention. The term “driver” applies to the occupant of the vehicle in a position to take the controls, but not necessarily controlling the driving. The expression “autonomous driving” signifies the automation of the driving of the vehicle, according to levels 3 or 4 of the definitions provided by the International Organization of Motor Vehicle Manufacturers (OICA). Finally, the term “scenario” applies to a group of configurations which control the autonomous driving of the vehicle in a given driving situation.

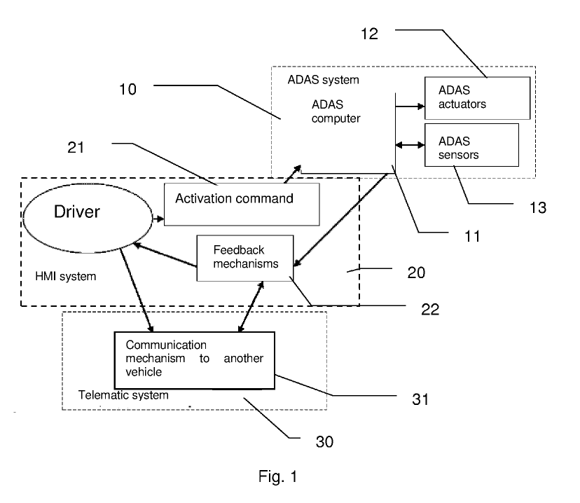

FIG. 1 presents a collection of technical means enabling the implementation of an autonomous driving method. It hence includes an advanced driver-assistance system (ADAS) 10, a human-machine interface system (HMI) 20, and a telematics system 30.

The ADAS system 10 includes a calculation unit in the form of a computer 11, as well as actuators 12 and sensors 13. The computer 11 is a state of the art computer system, including one or more microprocessors, memory units, input-output interfaces and a basic, preloaded program. An input-output interface connects the computer 11 to the actuators 12, which include state of the art devices which are capable of controlling the direction, accelerator, braking system and, potentially, the transmission of the vehicle.

Furthermore, another input-output interface connects the computer 11 to the sensors 13 according to the state of the art. These sensors can perceive the distinctive characteristics of one or more vehicles for recording by the computer 11 and therefore form, in combination with the computer 11, the first means of detection. They are also capable of perceiving the movements and/or indications of a vehicle located immediately in front or even in a parallel lane, in order to detect a situation in which the vehicle is no longer or will no longer be in a driving situation immediately behind a target vehicle, and they therefore form, in combination with the computer 11, the second means of detection. In combination with the actuators 12 and the computer 11, the sensors 13 also form the autonomous driving means, capable of maintaining the vehicle in a driving situation immediately behind a target vehicle, by reproducing the driving of the target vehicle. Finally, the sensors 13 and the computer 11 can analyze the position of the vehicle, as well as its speed, the environment in which the vehicle is moving and the position of other users, such as other vehicles, pedestrians and two-wheeled vehicles, and therefore form the control means.

The sensors 13 can be selected from amongst one or more visible light-sensitive cameras, one or more infrared light-sensitive cameras and one or more radars, laser radars (lidar) and ultrasonic sensors.

The same sensor can be included in the first detection means, the second detection means and the control means. Furthermore, positioning means such as a GPS receiver, Glonass and/or Galileo may be envisaged.

The computer 11 is also connected to the HMI system 20 in order to receive an activation command from the driver via an activation command system 21, as well as to transmit information to the driver or to the occupants of the vehicle via feedback mechanisms 22. The activation command system 21 can include a lever or dedicated button on the vehicle's dashboard, an icon on a touch screen or a voice command interface. The feedback mechanisms 22 can include indicators on the vehicle's dashboard, animations or representations on a screen fitted into the vehicle's interior compartment, as well as information delivered by voice or sounds. The activation command system 21 and the feedback mechanisms 22 therefore form the interface means.

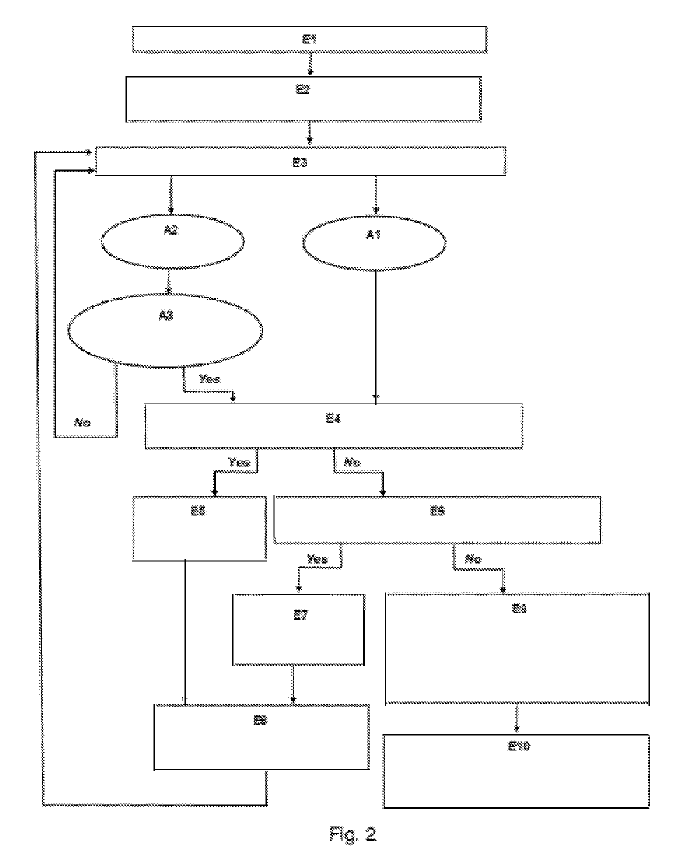

Finally, the HMI system 20 is connected to the telematics system 30 including one or more communication mechanisms 31 to another vehicle. These communication mechanisms can be selected from amongst a GSM system which is capable of communicating by SMS or mobile data, a radio system such as Bluetooth, Wi-Fi, ZigBee, Sarah and/or an optic communication system, such as infrared or Li-Fi. This telematics system 30 is capable of communicating with one or more other vehicles fitted with a compatible telematics system or even directly over the mobile phone of an occupant in another vehicle, for example, to transmit messages from the driver or occupants of the vehicle or even messages sent by the computer 11 through the feedback mechanisms 22. It could be simple information messages, for example, informing the occupants of a followed vehicle of an upcoming stop or a change of route, technical messages including breakdowns or faults in the vehicle as well as messages on the following status, when the vehicle follows the other vehicle autonomously as a target vehicle according to the method provided in detail in FIG. 2.

In reference to FIG. 2, the autonomous driving method includes a first step E1 (Activation of the “Target vehicle following” function) in which the function of following a target vehicle is activated by the vehicle's driver. This can be done when the vehicle is located immediately behind the target vehicle, or at least nearby.

The vehicle detects the distinctive characteristics of the target vehicle (step E2—Detection and recording of the distinctive characteristics of the target vehicle) by the first detection means, for example, the registration plate, the color, the general shape, the radar or lidar echo, or any impacts or stickers which are visible on the target vehicle. These distinctive characteristics are recorded in the computer 11 and potentially submitted to the driver of the vehicle for their approval via the HMI system 20. Hence, all vehicle types can be followed based on their external characteristics without requiring specific equipment.

The vehicle is therefore capable of autonomously following the target vehicle, which is to say without the driver intervening, by remaining immediately behind the target vehicle (step E3—Autonomous driving immediately behind the target vehicle). For example, using the ADAS system 10, the vehicle detects and reproduces the driving operations of the target vehicle, such as accelerations, braking, or changes in direction in order to stay within a traffic lane. Via the sensors 13, the vehicle continuously monitors its environment in order to foresee any dangerous maneuvers, in particular from another road user.

In the event that the target vehicle changes lane (action A1), for example to take a highway exit or interchange or to overtake a slow vehicle, or stays in the same lane (action A2), and a third vehicle comes between the vehicle and the target vehicle (action A3), the vehicle is therefore no longer located immediately behind the target vehicle and can therefore no longer detect the driving of the target vehicle. The vehicle detects this lane change via the second detection means, for example by recording the shift of the followed vehicle in relation to the traffic lane, materialized by ground markers, identifying a sudden increase in the distance away from the vehicle located immediately in front and/or by detecting a change of the distinctive characteristics of the vehicle located immediately in front. The lane change of the target vehicle can also be anticipated, for example by identifying a flashing turn-signal indicator on the target vehicle or even by identifying the lane changes required by a predefined route.

The vehicle therefore checks the possibility of executing a lane change according to a predefined scenario (step E4—Verification of the possibility of executing a lane change according to a predefined scenario). This verification is carried out by the computer 11 according to the information from the sensors 13, which is to say by the control means, in comparison to a predefined scenario. This scenario is predefined, for example, by the manufacturer or the importer of the vehicle, in the computer 11, and includes configurations such as the lane change speed, the lane change distance or the lane change duration, potentially according to the context in which the lane change is executed.

For example, this predefined scenario can include the scenario of a lane change at constant speed for the vehicle. The control means therefore assesses whether it is possible to change lane by maintaining the vehicle's speed without any danger, which is to say without inconveniencing other vehicles driving at higher speeds in the envisaged lane. If the possibility is validated, which is to say that the computer 11 determines that such a lane change is possible at a constant speed without any danger, the lane change is therefore executed according to this scenario by an appropriate action on the actuators 12 (step E5—Lane change according to the predefined scenario).

If a lane change according to the predefined scenario is not possible, for example due to an approaching third vehicle in the target vehicle's lane, the verification step starts again following another scenario, for example, which is configured by the driver or the owner of the vehicle and which includes at least one different confirmation in comparison to the predefined scenario (step E6—Verification of the possibility of executing a lane change according to another scenario). This configuration can be the lane change speed, a shorter duration or distance of the lane change, etc. For example, the driver was able to program a lane change speed greater than the driving speed. A verification is therefore made by the control means according to this other scenario, and if the verification has a positive result, which is to say the vehicle determines that it can execute the lane change without any danger according to this other scenario, the lane change is therefore executed by an appropriate action of the computer 11 on the actuators 12 (step E7—Lane change according to another scenario). For example, the vehicle will progressively accelerate up to the lane change speed while shifting into the desired lane, in order not to inconvenience or surprise another road user driving in this lane.

Once this step E7 for changing lane has been executed, the vehicle will carry out step E8 for recognizing the target vehicle using the sensors 13 and using the distinctive characteristics recorded in the computer 11 during step E2 (step E8—Recognition of the target vehicle using the distinctive characteristics). This step E8 can also be carried out after step E5 (Lane change according to the predefined scenario). This step E8 enables autonomous driving immediately behind the target vehicle to be autonomously resumed as soon as the target vehicle has been correctly recognized. When required, a second lane change is executed to return into the initial lane, for example, in the event that the target vehicle overtakes a slow vehicle or an obstacle and has therefore returned to the initial lane.

Hence, the vehicle implementing this method can maintain its driving situation immediately behind a target vehicle, without any communication with the target vehicle and without requiring any human intervention.

Optionally, the possibility of a lane change according to the other scenario is submitted to the driver for their prior approval during or before a journey, via the HMI system 20. The driver hence maintains indirect control of the autonomous driving and can adapt it depending on the desired comfort, their schedule or traffic conditions.

In the event that the lane change is not possible, the computer refers to the driver in step E9, using the HMI system, in order to offer them the option of continuing driving in autonomous mode, but without a target vehicle, which is to say, by deciding, either autonomously or under the driver's supervision, on the driving operations which have been previously executed, following the example of the target vehicle (step E9—Interaction with the occupant of a vehicle). Alternatively, the vehicle proposes that the driver resumes driving the vehicle in manual mode, which is to say that the driver directly takes over driving the vehicle.

After the driver has resumed driving in manual mode, the vehicle can continue to search for the target vehicle via the first means of detection and, once the target vehicle has been relocated, the vehicle can propose to the driver to resume autonomous driving immediately behind the target vehicle. Hence, the driver can be temporarily called upon to allow the vehicle to return to the driving situation immediately behind the target vehicle, for example, in cases of heavy traffic.

Optionally, the autonomous driving method can include a step E10 of communication with the target vehicle via the telematics system 30, for example, to transmit a message informing that following of the target vehicle has ended, or even to send a wait request so that the target vehicle slows down to wait for the vehicle (step E10—Communication with the target vehicle to send a “following ended” or “wait request” message). This communication step can be carried out from vehicle to vehicle in the case of a target vehicle equipped with a compatible telematics system, or even by means of a mobile phone or another mobile device belonging to an occupant of the vehicle.

It should be understood that various modifications and/or improvements, obvious to a person skilled in the art, may be made to the various embodiments of the invention which are described in this description, without exceeding the context or scope of the invention defined by the annexed claims. In particular, reference is made to the predefined scenario, which can also be adjusted by the driver or the owner of the vehicle, while the other scenario can potentially be chosen by the driver at the time of the lane change. Furthermore, several other scenarios can also be envisaged so as to give the computer and/or driver more possibilities. Alternatively, the computer can also determine a possible lane change scenario according to the driving environment and submit it to the driver for approval.

Furthermore, the vehicle can include any type of autonomous or semi-autonomous advanced driver-assistance system according to the state of the art. In addition, the vehicle according to this invention can be a motor vehicle, or a bus, truck or military vehicle

1. A method for autonomously driving a vehicle which allows the vehicle to maintain a driving situation immediately behind a target vehicle, wherein, the method includes the following steps:
a step (E2) of detecting and recording of the distinctive characteristics of the target vehicle (E2) by using a first detection means,
a step (E3) of autonomously driving immediately behind the said target vehicle, said step (E3) being executed by an autonomous driving means,
a step of detecting using a second detection means of a situation in which said vehicle is no longer or will no longer be in a driving situation immediately behind the target vehicle,
a step (E4) of verifying using a control means of the possibility of executing at least one lane change according to a predefined scenario, and
a step (E5) of executing the at least one lane change according to the said predefined scenario so that the said vehicle can resume the driving situation immediately behind the target vehicle (E5), said step (E5) being executed by the autonomous driving means.

2. The autonomous driving method according to claim 1, wherein the method includes a subsequent step (E8) of recognizing the target vehicle by the first detection means, using the distinctive characteristics recorded during the step (E2) of detecting and recording the distinctive characteristics of the target vehicle.

3. The autonomous driving method according to claim 1, wherein, if the step of verifying determines that a line change accordng to the predefined scenario is not possible, the step of verifying will be restarted with an alternative scenario, said alternative scenario including at least one configuration different from the said predefined scenario.

4. The autonomous driving method according to claim 3, wherein an execution step using autonomous driving means, of said at least one lane change according to the said alternative scenario is subject to the prior approval of an occupant of the vehicle via an interface.

5. The autonomous driving method according to claim 1, wherein the method includes an extra lane change, allowing for a third vehicle, positioned between the said vehicle and the said target vehicle, to be overtaken by said vehicle.

6. The autonomous driving method according to claim 1, wherein the method includes a step (E10) of communicating via a telematics system to inform the target vehicle or an occupant of the target vehicle that the said vehicle is no longer in a driving situation immediately behind the said target vehicle.

7. The autonomous driving method according to claim 1, wherein the method includes a step (E10) of communicating via a telematics system to transmit a request for the adjustment of the driving of the said target vehicle.

8. An autonomous driving device for a vehicle, said autonomous driving device including at least first detection means, a second detection means, a controller in communication with said first and second detection means, and an autonomous driving means in communication with said controller and which is configured to implement the autonomous driving method according to claim 1.

9. A vehicle including at least one autonomous driving device according to claim 8.

10. The autonomous driving device according to claim 8, in which the first and second detection means, the controller, and the autonomous driving means include one or more sensors, selected from amongst: visible light-sensitive camera, infrared light-sensitive camera, radar, laser radar and ultrasonic sensor, as well as at least one computer.

11. The vehicle according claim 9, in which the first and second detection means, the controller, and the autonomous driving means include one or more sensors selected from amongst: visible light-sensitive camera, infrared light-sensitive camera, radar, laser radar and ultrasonic sensor, as well as at least one computer.

12. The autonomous driving method according to claim 3, wherein said alternative scenario includes varying lane change speed, lane change distance, or lane change duration.
